(19) United States
(12) Patent Application Publication
(10) Pub. No.: US 2023/0415339 A1
(43) Pub. Date: Dec. 28, 2023

(54) ASSISTANCE CONTROL DEVICE, ASSISTANCE DEVICE, ROBOT CONTROL SYSTEM, ASSISTANCE CONTROL METHOD, AND STORAGE MEDIUM

(71) Applicant: NEC Corporation, Minato-ku, Tokyo (JP)

(72) Inventors: Masumi ICHIEN, Tokyo (JP); Masatsugu OGAWA, Tokyo (JP); Hisaya WAKAYAMA, Tokyo (JP)

(73) Assignee: NEC Corporation, Minato-ku, Tokyo (JP)

(21) Appl. No.: 18/037,241

(22) PCT Filed: Nov. 20, 2020
(86) PCT No.: PCT/JP2020/043445

§ 371 Date: May 16, 2023

(51) Int. Cl. B25J 9/16; B25J 9/00

(52) U.S. Cl. CPC B25J 9/1661; B25J 9/1679; B25J 9/0084

(57) ABSTRACT

An assistance control device 2X mainly includes an assistance request acquisition means 25X and a selection means 26X. The assistance request acquisition means 25X is configured to acquire assistance request information for requesting assistance, by external input, regarding a task to be executed by a robot. The selection means 26X is configured, if the assistance request information for plural tasks to be executed by plural robot is acquired, to select a task to be subjected to the assistance based on the assistance request information and work information regarding the plural robots.

### TECHNICAL FIELD

The present disclosure relates to the technical field of controlling the operation of a robot.

### BACKGROUND ART

There is proposed a control method for controlling a robot to execute a task when a task to be executed by the robot is given. For example, Patent Literature 1 discloses a system which is equipped with an automatic mode and a cooperative mode, and in the automatic mode, automatically controls the robot according to a sequence or a program, and in the cooperative mode, manually controls the robot by an on-hand operation panel by an operator. Further, Patent Literature 2 discloses a system for automatically selecting the operation mode at the time of determining that the task execution by the robot has failed when the failure of the motion planning (operation plan) of the robot is detected.

### CITATION LIST

### Patent Literature

Patent Literature 1: JP 2011-093062A
Patent Literature 2: JP 2016-068161A

### SUMMARY

### Problem to be Solved

For a system in which a robot performs a task, it is desirable that the robot can autonomously perform all of the operations necessary to complete the task, but there are cases in which manipulation by an operator is required for some of the operations. In such cases, it is necessary to cause the robot to operate properly and smoothly so that the task is completed. In addition, when there are multiple systems that let the robot execute tasks, it is necessary to appropriately select a target task of assistance.

In view of the issues described above, one object of the present invention is to provide an assistance control device, an assistance device, a robot control system, an assistance control method, and a storage medium capable of suitably selecting a robot task to be subjected to assistance.

### Means for Solving the Problem

In one mode of the assistance control device, there is provided an assistance control device including:
an assistance request acquisition means configured to acquire assistance request information for requesting assistance, by external input, regarding a task to be executed by a robot; and
a selection means configured, if the assistance request information for plural tasks to be executed by plural robot is acquired, to select a task to be subjected to the assistance based on the assistance request information and work information regarding the plural robots.

In one mode of the assistance control method, there is provided an assistance control method executed by a computer, the assistance control method including:
acquiring assistance request information for requesting assistance, by external input, regarding a task to be executed by a robot; and
if the assistance request information for plural tasks to be executed by plural robot is acquired, selecting a task to be subjected to the assistance based on the assistance request information and work information regarding the plural robots.

In one mode of the storage medium, there is provided a storage medium storing a program executed by a computer, the program causing the computer to:
acquire assistance request information for requesting assistance, by external input, regarding a task to be executed by a robot; and
if the assistance request information for plural tasks to be executed by plural robot is acquired, select a task to be subjected to the assistance based on the assistance request information and work information regarding the plural robots.

### Effect

An example advantage according to the present invention is to suitably select a robot task to be subjected to assistance.

### BRIEF DESCRIPTION OF THE DRAWINGS

FIG. 1 It illustrates a configuration of a robot control system in the first example embodiment.

FIG. 2A illustrates the hardware configuration of a robot controller.

FIG. 2B illustrates the hardware configuration of an assistance device.

FIG. 2C illustrates the hardware configuration of a management device.

FIG. 3 It illustrates an example of the data structure of application information.

FIG. 4 It illustrates an example of a functional block of the robot control system.

FIG. 5 It is a diagram illustrating subtasks performed by a plurality of robots and the dependence relation among the subtasks.

FIG. 6 It is a diagram showing the order of arrivals of target subtasks of assistance, the priority scores of the target subtasks, and the execution order of the target subtasks.

FIG. 7 It is an example of a functional block showing a functional configuration of the operation sequence generation unit.

FIG. 8 It illustrates an example of a robot operation screen image.

FIG. 9 It illustrates an example of a flowchart indicating an outline of a robot control process in the first example embodiment.

FIG. 10 It illustrates a functional configuration of the robot control system according to a second example embodiment.

FIG. 11 It illustrates a functional configuration of the robot control system according to a third example embodiment.

FIG. 12 It is a schematic configuration diagram of an assistance control device in a fourth example embodiment.

FIG. 13 It illustrates an example of a flowchart indicating the process executed by the assistance control device in the fourth example embodiment.

### EXAMPLE EMBODIMENTS

Hereinafter, example embodiments in the present disclosure will be described with reference to the drawings.

### First Example Embodiment

(1) System Configuration

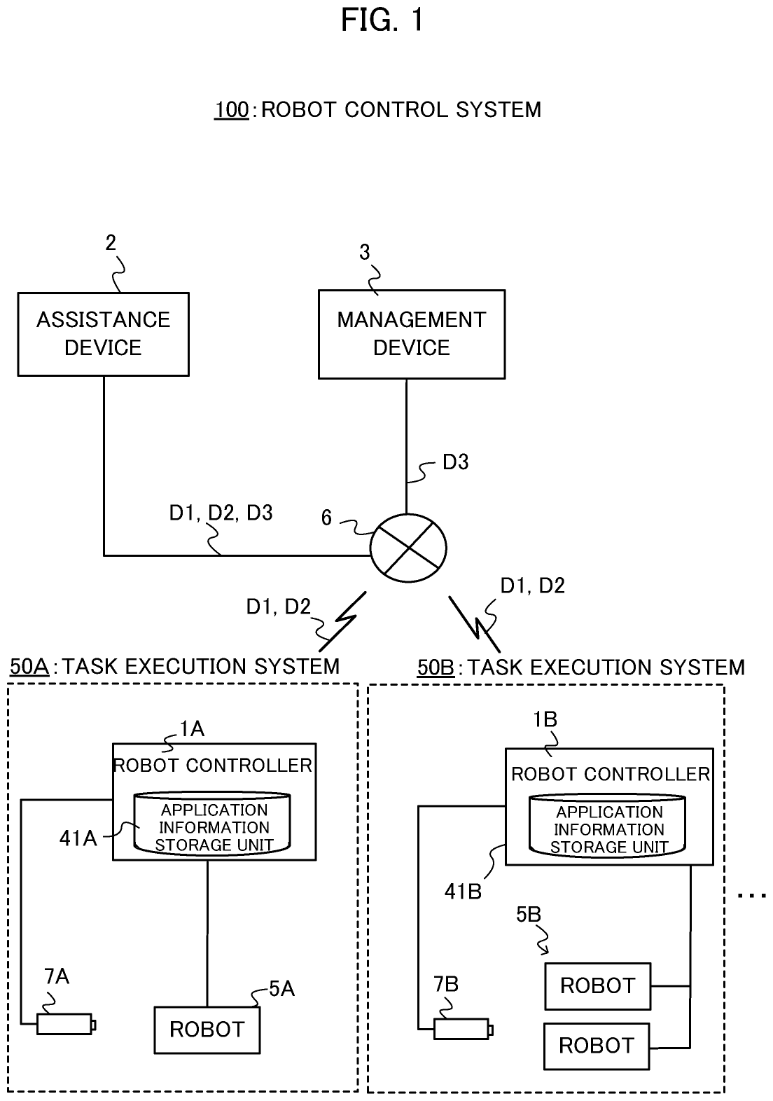

FIG. 1 shows a configuration of a robot control system 100 according to the first example embodiment. The robot control system 100 primarily has an assistance device 2, a management device 3, and a plurality of task execution systems 50 (50A, 50B, . . . ). The assistance device 2, the management device 3, and the task execution systems 50 perform data communication via the communication network 6 with one another.

The assistance device 2 is a device configured to assist operations necessary for the robots in the task execution systems 50 to execute tasks. Specifically, when the assistance request information “D1” for requesting assistance is supplied from any of the task execution systems 50, the assistance device 2 transmits an external input signal “D2” generated based on the operation (manipulation) of the operator to the task execution system 50 of interest. Here, the external input signal D2 is an input signal from an operator representing a command which directly specifies the operation of the robot 5 that needs to be assisted. The assistance device 2 may further accept the input from the operator specifying the task (also referred to as “objective task”) to be executed in a task execution system 50 to thereby transmit information specifying the objective task to the task execution system 50 of interest. The assistance device 2 may be a tablet terminal equipped with an input unit and a display unit, or may be a stationary personal computer.

The management device 3 is a device configured to manage the entire work process in the robot control system 100. The management device 3 transmits information (also referred to as “work process information D3”) regarding the entire work process in the robot control system 100 to the assistance device 2 in response to the request from the assistance device 2. The work process information D3 at least includes information regarding the dependence relation among the tasks to be performed by the robots 5 of the task execution systems 50.

The task execution systems 50 are systems that execute specified objective tasks and are provided in different environments. Each of the task execution systems 50 includes a robot controller 1 (1A, 1B, . . . ), a robot 5 (5A, 5B, . . . ) and a measurement device 7 (7A, 7B, . . . ).

When the objective task to be executed by the robot 5 belonging to the task execution system 50 to which the robot controller 1 belongs is specified, the robot controller 1 formulates the motion planning of the robot 5 based on the temporal logic and controls the robot 5 based on the motion planning. Specifically, the robot controller 1 converts the objective task represented by temporal logic into a sequence of tasks, each of which is in a unit of time step and can be accepted by the robot 5, and controls the robot 5 based on the generated sequence. Hereinafter, each task (command) into which the objective task is decomposed by a unit that the robot 5 can accept is also referred to as “subtask”, and a sequence of subtasks to be executed by the robot 5 to accomplish the objective task is referred to as “subtask sequence” or “operation sequence”. As described later, the subtask includes one or more tasks that require assistance (i.e., manual control) by the assistance device 2.

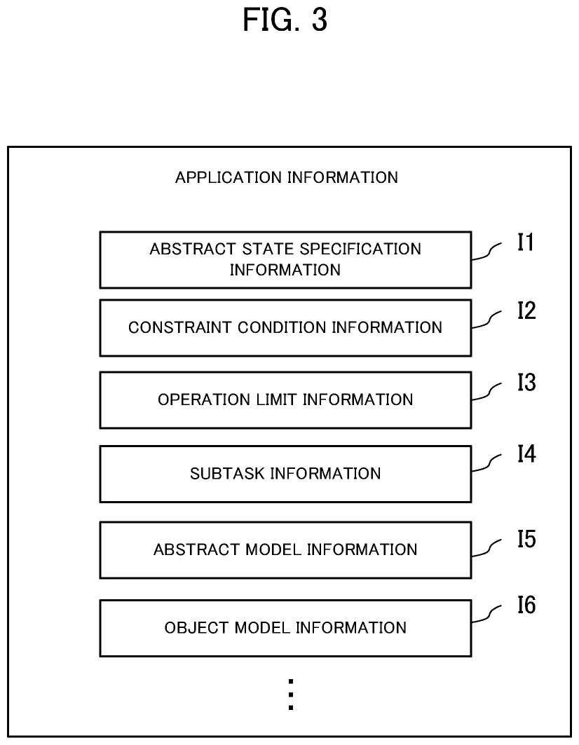

Further, the robot controller 1 is equipped with an application information storage unit 41(41A, 41B, . . . ) for storing application information to be required for generating the operation sequence of the robot 5 from the objective task. Details of the application information will be described later with reference to FIG. 3.

Further, the robot controller 1 performs data communication with the robot 5 and the measurement device 7 belonging to the task execution system 50 where the robot controller 1 belongs via a communication network or by wireless or wired direct communication. For example, the robot controller 1 transmits a control signal relating to the control of the robot 5 to the robot 5. In another example, the robot controller 1 receives a measurement signal generated by the measurement device 7. Furthermore, the robot controller 1 performs data communication with the assistance device 2 through the communication network 6.

One or more robots 5 are provided in each of the task execution systems 50, and perform work related to the objective task on the basis of a control signal supplied from the robot controller 1 belonging to the task execution system 50 where the robots 5 belong. Examples of the robots include a robot used in an assembly factory, a food factory, or any other factory and a robot configured to operate in logistics sites. The robot 5 may be a vertical articulated robot, a horizontal articulated robot, or any other type of a robot and may be equipped with plural targets to be controlled to operate independently such as robot arms. Further, the robot 5 may perform cooperative work with other robots, workers, or machine tools that operate in the workspace. Further, the robot controller 1 and the robot 5 may be integrally configured.

Further, the robot 5 may supply a state signal indicating the state of the robot 5 to the robot controller 1 belonging to the task execution system 50 to which the robot 5 belongs. The state signal may be an output signal from one or more sensors for detecting the state (e.g., position and angle) of the entire robot 5 or specific parts such as a joint, or may be a signal indicating the progress of the operation sequence of the robot 5 supplied to the robot 5.

The measurement device 7 is one or more sensors, such as a camera, a range sensor, a sonar, and any combination thereof, to detect a state of the workspace in which the objective task is performed in each task execution system 50. The measurement device 7 supplies the generated measurement signal to the robot controller 1 belonging to the task execution system 50 to which the measurement device 7 belongs. The measurement device 7 may be a self-propelled or flying sensor (including a drone) that moves in the workspace. The measurement device 7 may also include one or more sensors provided on the robot 5, one or more sensors provided on other objects existing in the workspace, and the like. The measurement device 7 may also include one or more sensors that detect sound in the workspace. As such, the measurement device 7 may include a variety of sensors that detect the state of the workspace, and may include sensors located anywhere.

The configuration of the robot management system 100 shown in FIG. 1 is an example, and therefore various changes may be made to the configuration. For example, the robot controller 1 that exists in each task execution system 50 may be configured by a plurality of devices. In this case, the plurality of devices constituting the robot controller 1 exchange information necessary to execute the process assigned in advance with one another. The application information storage unit 41 may be stored by one or more external storage devices that perform data communication with the robot controller 1. In this case, the external storage devices may be one or more server devices for storing the application information storage unit 41 commonly referenced in each task execution system 50.

(2) Hardware Configuration

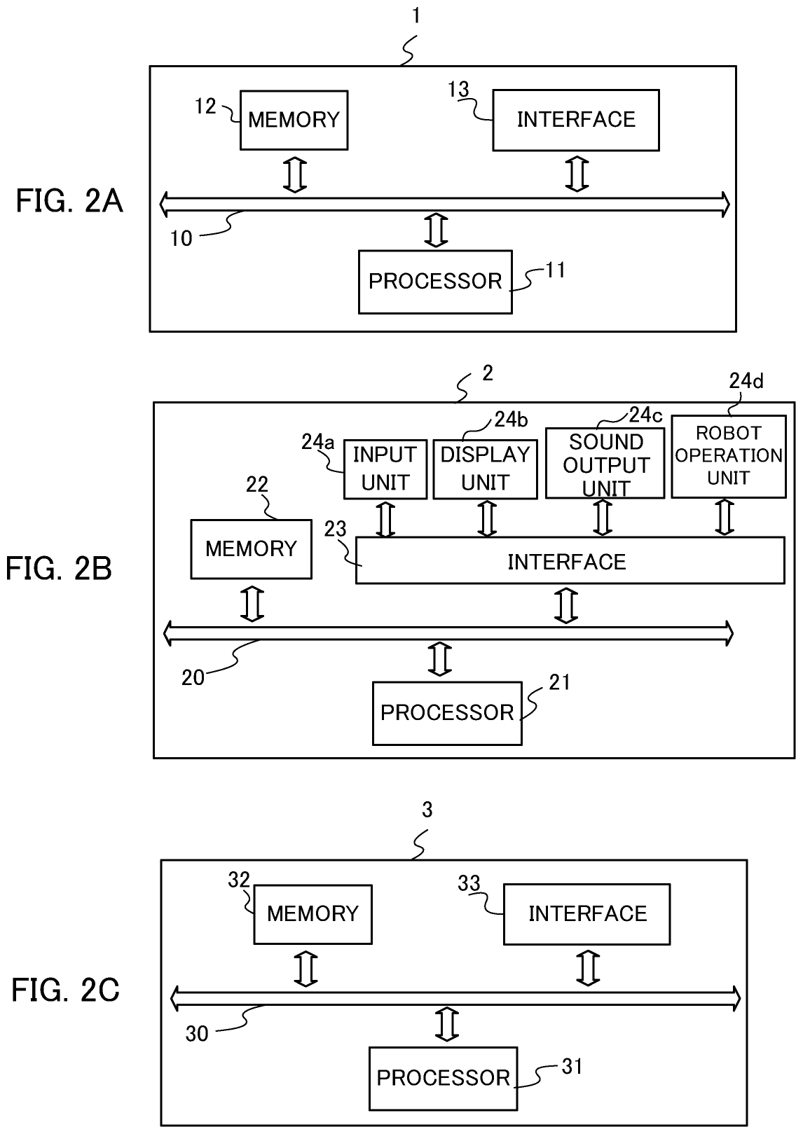

FIG. 2A shows the hardware configuration of the robot controller 1 (1A, 1B, . . . ). The robot controller 1 includes a processor 11, a memory 12, and an interface 13 as hardware. The processor 11, the memory 12 and the interface 13 are connected to one another via a data bus 10.

The processor 11 executes a program stored in the memory 12 thereby to function as a controller (arithmetic unit) for performing overall control of the robot controller 1. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile and non-volatile memories, such as a RAM (Random Access Memory), a ROM (Read Only Memory), and a flash memory. Further, in the memory 12, a program for the robot controller 1 to execute a process is stored. The memory 12 functions as the application information storage unit 41. A part of the information stored in the memory 12 may be stored by one or a plurality of external storage devices capable of communicating with the robot controller 1, or may be stored by a storage medium detachable from the robot controller 1.

The interface 13 is one or more interfaces for electrically connecting the robot controller 1 to other devices. Examples of the interfaces include a wireless interface, such as a network adapter, for transmitting and receiving data to and from other devices wirelessly, and a hardware interface, such as a cable, for connecting to other devices.

The hardware configuration of the robot controller 1 is not limited to the configuration shown in FIG. 2A. For example, the robot controller 1 may be connected to or incorporate at least one of a display device, an input device, and a sound output device.

FIG. 2B shows the hardware configuration of the assistance device 2. The assistance device 2 includes, as hardware, a processor 21, a memory 22, an interface 23, an input unit 24a, a display unit 24b, a sound output unit 24c, and a robot operation unit 24d. The processor 21, memory 22 and interface 23 are connected to one another via a data bus 20. Further, the interface 23 is connected to the input unit 24a and the display unit 24b and the sound output unit 24c and the robot operation unit 24d.

The processor 21 executes a predetermined process by executing a program stored in the memory 22. The processor 21 is one or more processors such as a CPU, a GPU, and a TPU. The processor 21 controls at least one of the display unit 24b and the sound output unit 24c through the interface 23 based on the information received from the task execution system 50 via the interface 23. Thus, the processor 21 presents, to the operator, information that assists the operation to be executed by the operator using the robotic operation unit 24d. The processor 21 transmits the external input signal D2 that is a signal generated by the robot operation unit 24d to the task executing system 50, which is the sender of the assistance request information D1, through the interface 23. The processor 21 may be configured by a plurality of processors. The processor 21 is an example of a computer.

The memory 22 is configured by various volatile memories and non-volatile memories such as a RAM, a ROM, a flash memory, and the like. Further, in the memory 22, a program for the assistance device 2 to execute a process is stored.

The interface 23 is one or more interfaces for electrically connecting the assistance device 2 to other devices. Examples of the interfaces include a wireless interface, such as a network adapter, for transmitting and receiving data to and from other devices wirelessly, and a hardware interface, such as a cable, for connecting devices to other devices. The interface 23 also performs interface operations of the inputting unit 24a, the display unit 24b, the sound output unit 24c, and the robot operation unit 24d. The input unit 24a is one or more interfaces configured to receive input from a user, and examples thereof include a touch panel, a button, a keyboard, and a voice input device. Examples of the display unit 24b include a display and a projector and it is configured to display information under the control of the processor 21. Examples of the sound output unit 24c include a speaker and it is configured to perform sound output under the control of the processor 21.

The robot operation unit 24d is configured to receive an external input that is an input from a user representing a command which directly specifies an operation (motion) of the robot 5 and generates an external input signal D2 that is a signal of the external input. Here, the robot operation unit 24d may be a robot controller (operation panel) operated by the user in the control of the robot 5 based on the external input, or may be a robot input system configured to generate an operation command to the robot 5 in accordance with the movement of the user. The former robot controller includes, for example, various buttons for designating the part of the robot 5 to be moved and designating the movement thereof and an operation bar for designating the movement direction. The latter robot input system includes various sensors (e.g., including a camera and a mounting sensor) to be used in motion capture, for example.

Hereinafter, the control (i.e., the automatic control of the robot 5) of the robot 5 based on the operation sequence generated by the robot controller 1 is referred to as “first robot control”, and the control (i.e., the manual control of the robot 5 based on the external input) of the robot 5 using the robot operation unit 24d is referred to as “second robot control”.

The hardware configuration of the assistance device 2 is not limited to the configuration shown in FIG. 2B. For example, at least one of the input unit 24a, the display unit 24b, the sound output unit 24c, and the robot operation unit 24d may be configured as a separated device that electrically connects to the assistance device 2. In addition, the assistance device 2 may be connected to various devices such as a camera, or may incorporate them.

FIG. 2C shows the hardware configuration of the management device 3. The management device 3 includes a processor 31, a memory 32, and an interface 33 as hardware. The processor 31, the memory 32 and the interface 33 are connected to one another via a data bus 30.

The processor 31 executes a program stored in the memory 32 thereby to function as a controller (computing unit) for controlling the entire management device 3. The processor 31 is, for example, a processor such as a CPU, a GPU, and a TPU. The processor 31 may be configured by a plurality of processors.

The memory 32 is configured by a variety of volatile and non-volatile memories, such as a RAM, a ROM, a flash memory, and the like. Further, the memory 32 stores a program for the management device 3 to execute a process. The memory 32 stores work process information D3. The work process information D3 may be information that is automatically generated by the processor 31 and stored in the memory 32, or may be information that is generated based on the input from an administrator (not shown) by an input unit connected via the interface 33 and stored in the memory 32. In the former instance, the processor 31 generates the work process information D3 based on information received from the robot controller 1 of each task execution system 50 and other associated devices associated with the work of the robot 5.

The interface 33 is one or more interfaces for electrically connecting the management device 3 to other devices. Examples of the interfaces include a wireless interface, such as a network adapter, for transmitting and receiving data to and from other devices wirelessly, and a hardware interface, such as a cable, for connecting devices to other devices.

The hardware configuration of the management device 3 is not limited to the configuration shown in FIG. 2C. For example, the management device 3 may be connected to or corporate at least one of a display device, an input device, and a sound output device.

(3) Application Information

Next, a data structure of the application information stored in the application information storage unit 41 will be described.

FIG. 3 shows an example of a data structure of the application information. As shown in FIG. 3, the application information includes abstract state specification information I1, constraint condition information I2, operation limit information I3, subtask information I4, abstract model information I5, and object model information I6.

The abstract state specification information I1 specifies an abstract state to be defined in order to generate the operation sequence. The above-mentioned abstract state is an abstract state of an object in the workspace, and is defined as a proposition to be used in the target logical formula to be described later. For example, the abstract state specification information I1 specifies the abstract state to be defined for each type of objective task.

The constraint condition information I2 indicates constraint conditions at the time of performing the objective task. The constraint condition information I2 indicates, for example, a constraint that the robot 5 (robot arms) must not be in contact with an obstacle when the objective task is pick-and-place, and a constraint that the robot arms must not be in contact with each other, and the like. The constraint condition information I2 may be information in which the constraint conditions suitable for each type of the objective task are recorded.

The operation limit information I3 indicates information on the operation limit of the robot 5 to be controlled by the robot controller 1. The operation limit information I3 is information, for example, defining the upper limits of the speed, the acceleration, and the angular velocity of the robot 5. It is noted that the operation limit information I3 may be information defining the operation limit for each movable portion or joint of the robot 5.

The subtask information I4 indicates information on subtasks that are possible components of the operation sequence. The term “subtask” herein indicates a task, in a unit which can be accepted by the robot 5, obtained by decomposing the objective task and is equivalent to a segmentalized operation of the robot 5. For example, when the objective task is pick-and-place, the subtask information I4 defines a subtask “reaching” that is the movement of a robot arm of the robot 5, and a subtask “grasping” that is the grasping by the robot arm. The subtask information I4 may indicate information relating to subtasks that can be used for each type of objective task.

Further, the subtask information I4 includes information on subtasks (also referred to as “external input specific subtasks”) which require operation commands by external input (i.e., which are assumed to be performed under the second robot control). In this case, for example, the subtask information I4 regarding the external input specific subtask includes: subtask identification information; flag information for identifying the external input specific subtask; and information relating to the operation content of the robot 5 in the external input specific subtask. In addition, the subtask information I4 regarding the external input specific subtask may further include text information for requesting the assistance device 2 to send the external input and information relating to the assumed working time length.

The abstract model information I5 is information on an abstract model in which the dynamics in the workspace are abstracted. For example, an abstract model is represented by a model in which real dynamics are abstracted by a hybrid system, as will be described later. The abstract model Information I5 includes information indicative of the switching conditions of the dynamics in the above-mentioned hybrid system. For example, in the case of pick-and-place in which the robot 5 grasps an object (referred to as “target object”) to be targeted by the robot 5 and then place it on a predetermined position, one of the switching conditions is that the target object cannot be moved unless it is gripped by the hand of the robot arm. The abstract model information I5 includes information on an abstract model suitable for each type of the objective task.

The object model information I6 is information on the object model of each object in the workspace to be recognized from the signal generated by the measurement device 7. Examples of the above-described each object include the robot 5, an obstacle, a tool and any other object handled by the robot 5, a working body other than the robot 5. The object model information I6 includes, for example, information required for the control device 1 to recognize the type, position, posture, currently-executed operation, and the like of the described above each object, and three-dimensional shape information such as CAD (Computer Aided Design) data for recognizing the three-dimensional shape of each object. The former information includes the parameters of an inference engine obtained by learning a learning model that is used in a machine learning such as a neural network. For example, the above-mentioned inference engine is preliminarily learned to output the type, the position, the posture, and the like of an object shown in the image when an image is inputted thereto.

The application information storage unit 41 may store not only the information described above but also various information relating to the process of generating the operation sequence and display process in the second robot control.

(4) Process Overview

Next, a process overview of the robot control system 100 in the first example embodiment will be described. Schematically, when receiving a plurality of the assistance request information D1, the assistance device 2 determines the degree of execution priority (priority score) for each assistance request information D1 based on the work information regarding the robot 5. Thus, the assistance device 2 suitably provides the assistance to the task execution system 50 so that the entire work process of the robot control system 100 proceeds smoothly. The process of determining the degree of priority (priority score) will be described in detail in “(5) Details of Selection Unit” described later.

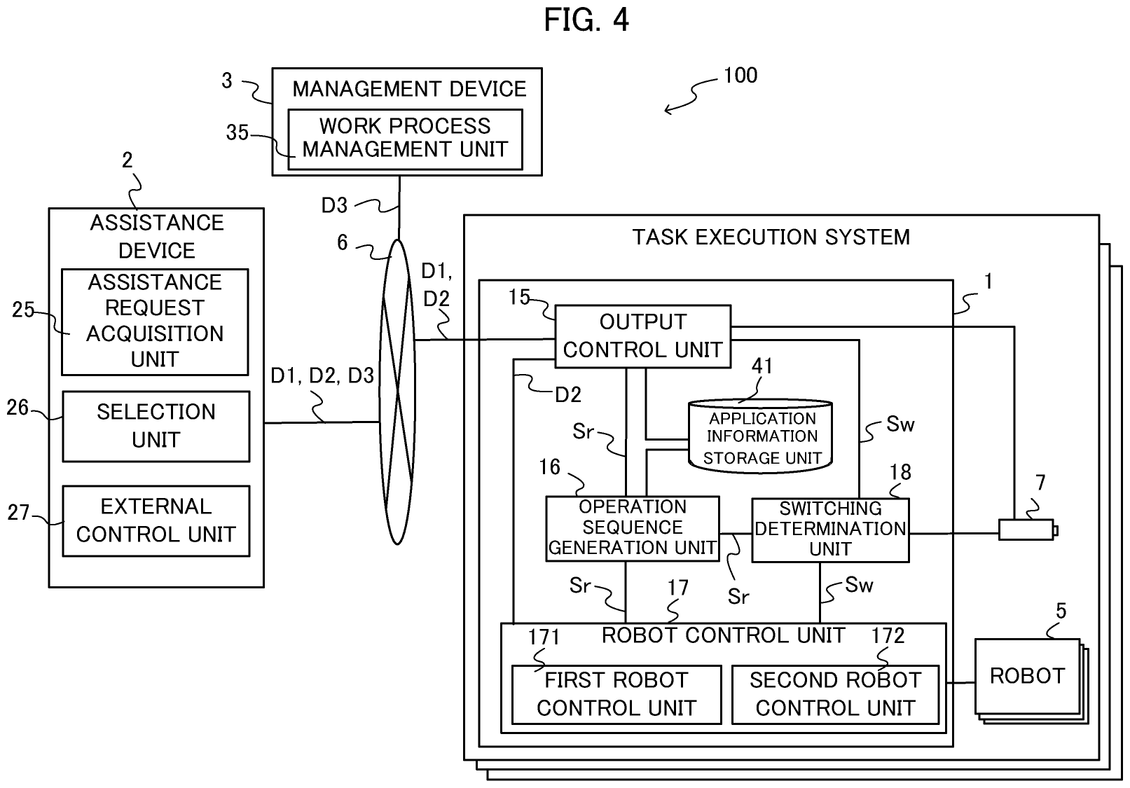

FIG. 4 is an example of functional blocks showing an outline of the process in the robot control system 100. The processor 11 of the robot controller 1 functionally includes an output control unit 15, an operation sequence generation unit 16, a robot control unit 17, and a switching determination unit 18. The processor 21 of the assistance device 2 functionally includes an assistance request acquisition unit 25, a selection unit 26, and an external control unit 27. The processor 31 of the management device 3 functionally includes a work process management unit 35. In the functional block of the robot controller 1, any blocks to exchange data with each other are connected to each other by solid line. However, the combinations of the blocks to exchange data and the data to be exchanged are not limited to the ones as shown in FIG. 4. The same applies to the drawings of other functional blocks described below.

First, a description will be given of the function of the robot controller 1. Schematically, during the execution of the first robot control, if the robot controller 1 determines, based on the operation sequence, that it is necessary to switch from the first robot control to the second robot control, the robot controller 1 transmits the assistance request information D1 to the assistance device 2. Thereby, even when the automatic control of the robot 5 is not enough to deal with the situation, the robot controller 1 smoothly switches the control mode of the robot 5 to the second robot control to suitably complete the objective task.

The output control unit 15 performs a process relating to the transmission of the assistance request information D1 and the reception of the external input signal D2 through the interface 13. In this case, if the output control unit 15 receives the switching command “Sw” for switching to the second robot control from the switching determination unit 18, it transmits the assistance request information D1 for requesting a required external input to the assistance device 2. Here, the assistance request information D1 includes, for example, the identification information of a target robot 5 (and a target task execution system 50) of assistance, the identification information of a target subtask of assistance, the assumed work time length of the target subtask, and the required operation content of the robot 5. The target subtask of assistance may be a plurality of subtasks to be executed in a row. In addition, if the output control unit 15 receives information indicating that the assistance is provided as a response of the assistance request information D1 from the assistance device 2, the output control unit 15 transmits to the assistance device 2 information (also referred to as “operation screen image information”) to be required for displaying the operation screen image for the operator of the assistance device 2. If the output control unit receives the outer input signal D2 from the assistance device 2, the output control unit 15 supplies the external input signal D2 to the robot control unit 17.

The operation sequence generation unit 16 generates the operation sequence “Sr” of the robot 5 to be required to complete the specified objective task, based on the signal outputted by the measurement device 7 and the application information. The operation sequence Sr corresponds to a sequence (subtask sequence) of subtasks to be executed by the robot 5 in order to complete the objective task, and specifies a series of operations (motions) of the robot 5. Then, the operation sequence generation unit 16 supplies the generated operation sequence Sr to the robot control unit 17 and the switching determination unit 18. Here, the operation sequence Sr includes information indicating the execution order and execution timing of each of the subtasks.

The robot control unit 17 controls the operation of the robot 5 by supplying a control signal to the robot 5 through the interface 13. The robot control unit 17 functionally includes a first robot control unit 171 and a second robot control unit 172. The robot control unit 17 performs the control (i.e., the first robot control) of the robot 5 by the first robot control unit 171 after receiving the operation sequence Sr from the operation sequence generation unit 16. Then, based on the switching command Sw supplied from the switching determination unit 18, the robot control unit 17 switches the control mode of the robot 5 to the control (i.e., the second robot control) of the robot 5 by the second robot control unit 172.

The first robot control unit 171 performs processing for controlling the robot 5 by the first robot control. In this instance, the first robot control unit 171 performs control of the robot 5 to execute the respective subtasks constituting the operation sequence Sr at respectively specified execution timing (time step) based on the operation sequence Sr supplied from the operation sequence generation unit 16. Specifically, the robot control unit 17 executes the position control, the torque control, or the like of the joints of the robot 5 for realizing the operation sequence Sr by transmitting the control signal to the robot 5.

The second robot control unit 172 performs processing for controlling the robot 5 by the second robot control. In this instance, the second robot control unit 172 receives the external input signal D2 generated by the robot operation unit 24d of the assistance device 2 from the assistance device 2 through the interface 13. The external input signal D2, for example, includes information specifying specific motion (operation) of the robot 5 (e.g., information corresponding to the control input which directly specifies the motion of the robot 5). Then, the second robot control unit 172 generates a control signal based on the received external input signal D2, and transmits the generated control signal to the robot 5 to control the robot 5. Here, the control signal generated by the second robot control unit 172 is, for example, a signal obtained by converting the external input signal D2 into data in a data format that the robot 5 can accept. When such a converting process is performed in the robot 5, the second robot control unit 172 may supply the robot 5 with the external input signal D2 as it is as the control signal.

The robot 5 may have a function corresponding to the robot control unit 17 instead of the robot controller 1. In this instance, the robot 5 performs the first robot control and the second robot control while switching between them based on: the operation sequence Sr generated by the operation sequence generation unit 16; the switching command Sw generated by the switching determination unit 18; and the external input signal D2.

The switching determination unit 18 determines the necessity of switching from the first robot control to the second robot control based on the operation sequence Sr or the like. Then, if the switching determination unit 18 determines that switching from the first robot control to the second robot control is required, the switching determination unit 18 supplies the output control unit 15 and the robot control unit 17 with the switching command Sw instructing the switching from the first robot control to the second robot control.

The switching determination unit 18 may specify, based on the operation sequence Sr or the like, at least one of the timing of switching from the first robot control to the second robot control and the content of the process of the subtask(s) in the second robot control. In this case, the switching determination unit 18 may transmit the switching command Sw to the output control unit 15 in accordance with the timing, so that the output control unit 15 transmits the assistance request information D1 indicating at least one of the specified timing and the content of the subtask to the assistance device 2. In this case, for example, at the timing when a condition for transmitting the assistance request information D1 to the assistance device 2 is satisfied, the output control unit 15 may transmit the assistance request information D1 indicating the timing and the subtask. For example, the condition is a condition for determining whether or not now is a predetermined timing before (e.g., five minutes before, one minute before, and thirty seconds before) the start of the subtask in the second robot control. In other words, the switching determination unit 18 specifies the timing to start the selected subtask, and the output control unit may transmit to the assistance device 2 the assistance request information D1 indicating the start timing that is ahead of the timing specified by the switching determination unit 18. Alternatively, the switching determination unit 18 specifies the timing to start the selected subtask and the content of the process of the subtask, and the output control unit 15 may send the assistance request information D1 representing the content of the process of the subtask to the assistance device 2 before the timing specified by the switching determination unit 18.

The switching determination unit 18 may further provide a start button or the like for instructing the start of the second robot control. The start button may be implemented as not only an image but also a query by voice. In other words, the switching determination unit 18 may further provide a function of receiving a start command of the second robot control. The switching determination unit 18 may supply the switching command Sw to the output control unit and the robot control unit 17 if it detects that the start button is pressed.

During the execution of the external control mode, if there occurs a subtask which requires the second robot control and whose priority score is high (i.e., higher than a predetermined threshold) as a subtask to be executed, the switching determination unit 18 specifies at least one of the start timing of the subtask with the high priority score and the content of the subtask in the second robot control and transmits the switching command Sw to the output control unit 15 so that the output control unit 15 transmits the assistance request information D1 representing at least one of the specified timing and the content of the subtask to the assistance device 2. The switching determination unit 18 may further provide a switching button or the like for instructing to interrupt the ongoing external control and switch to the subtask with the high priority score. The switching button may be implemented as not only an image but also a query by voice. In other words, the switching determination unit 18 may further provide a function of receiving a command to switch to the subtask with the high priority score. The switching determination unit 18 may supply the switching command Sw to the output control unit 15 and the robot control unit 17 if it detects that the switching button is pressed. Then, in this case, the output control unit 15 transmits the assistance request information D1 instructing to switch to the subtask with the high priority score to the assistance device 2. Thereafter, if the target subtask is completed, the output control unit may instruct the assistance device 2 and the robot control unit 17 to restart the interrupted external control.

Next, a description will be given of the functional blocks of the assistance device 2.

The assistance request acquisition unit 25 receives the assistance request information D1 from the task execution system 50 that requires assistance by the assistance device 2 through the interface 23. The assistance request acquisition unit 25 supplies the received assistance request information D1 to the selection unit 26.

The selection unit 26 selects the assistance request information D1 associated with a subtask to be subjected to external control by the external control unit 27 (i.e., generation and transmission of the external input signal D2 required for the second robot control).

Specifically, if the external control by the external control unit 27 is ongoing at the time when the assistance request acquisition unit 25 receives the assistance request information D1, the selection unit 26 calculates a score (also referred to as “priority score Sp”) representing the degree of execution priority for the subtask indicated by the received assistance request information D1. In this instance, the selection unit 26 calculates the priority score Sp based on the work information of the robot 5 such as the work process information D3 received from the management device 3, as will be described later. Then, the assistance request information D1 for which the priority score Sp is calculated is shifted to the waiting state. Then, when the ongoing external control by the external control unit 27 is completed, the selection unit 26 selects, from the assistance request information D1 in the waiting state, the assistance request information D1 with the highest priority score Sp and supplies it to the external control unit 27. If there is no ongoing external control 1 by the external control unit 27 at the time when the assistance request acquisition unit 25 receives the assistance request information D1 (i.e., if the external control by the external control unit 27 is available), the selection unit 26 supplies the received assistance request information D1 to the external control unit 27.

Based on the assistance request information D1 selected by the selection unit 26, the external control unit 27 performs external control of the robot 5 for executing the subtask corresponding to the assistance request information D1. Specifically, the external control unit 27 generates the external input signal D2 according to the operator's operation by use of the robot operation unit 24d and transmits the generated external input signal D2 to the task execution system 50 that is the sender of the assistance request information D1 via the interface 23. In this instance, for example, the external control unit 27 firstly transmits information indicating that assistance is to be provided to the task executing system 50 that is the sender of the assistance request information D1 selected by the selection unit 26, and then receives the operation screen image information as the response thereof. The external control unit 27 displays on the display unit 24b a screen image (also referred to as “robot operation screen image”) for operating the target robot 5 by the robot operation unit 24d on the basis of the received operation screen image information. On the robot operation screen image, for example, information regarding the content of the operation (motion) of the robot 5 to be specified by an external input is displayed. For example, the external control unit 27 generates the external input signal D2 and transmits the external input signal D2 on a real time basis in response to the operator's operation by the robot operation unit 24d.

The work process control unit 35 of the management device 3 transmits, in response to the request from the assistance device 2, the work process information D3 including information regarding the dependence relation among the tasks (objective task and subtasks) to be executed by the task execution system 50 to the assistance device 2.

Here, for example, each component of the assistance request acquisition unit 25, the selection unit 26, and the external control unit 27 can be realized by the processor 11 executing a program. Additionally, the necessary programs may be recorded on any non-volatile storage medium and installed as necessary to realize each component. It should be noted that at least some of these components may be implemented by any combination of hardware, firmware, and software, or the like, without being limited to being implemented by software based on a program. At least some of these components may also be implemented by a user programmable integrated circuit such as a FPGA (Field-Programmable Gate Array) and a microcontroller. In this case, the integrated circuit may be used to realize a program functioning as the above components. At least some of the components may also be configured by an ASSP (Application Specific Standard Produce), an ASIC (Application Specific Integrated Circuit), or a quantum computer-controlled chip. Accordingly, each component may be implemented by any kind of hardware. The above is true for other example embodiments described later. Furthermore, each of these components may be implemented by the cooperation of a plurality of computers, for example, using cloud computing technology. The same applies to the components of the management device 3 shown in FIG. 4 and the components of the robot controller 1 shown in FIG. 4.

(5) Details of Selection Unit

First, a description will be given of a method of calculating the priority score Sp calculated for each assistance request information D1 (i.e., for each subtask to be assisted) that specifies the subtask to be assisted.

(5-1) Calculation of Priority Scores Based on Work Process Information

The selection unit 26 determines the priority score Sp based on the work process information D3. In this instance, the selection unit 26 sets the priority score Sp based on the dependence relation among the tasks (objective task and subtasks) indicated by the work process information D3 so that the more important a task is in consideration of the work efficiency of the entire robot control system 100, the higher value is set as the priority score Sp corresponding to the task. Specifically, in a case where the completion of a target subtask of the calculation of the priority score Sp becomes a necessary condition for starting another subtask of the other robot 5 other than the robot 5 that executes the target subtask, the selection unit 26 sets a higher priority score Sp corresponding to the target subtask than the priority score Sp to be set in the case where the completion of the target subtask does not become the necessary condition. Hereafter, a robot (limited to a robot 5 other than the robot 5 which executes the target subtask) which cannot execute a planned subtask unless the target subtask of the calculation of the priority score Sp is completed is also referred to as “dependent robot”. The dependent robot may be the robot 5 which belongs to the task execution system 50 where the robot 5 that executes the target subtask of calculation of the priority score Sp belongs, or may be the robot 5 which belongs to any other task execution system 50.

At this time, preferably, the selection unit 26 may set the priority score Sp to a value which increases with increase in the number of the dependent robots. Thereby, the higher the influence on the tasks of the other robots 5 is, the higher value is set as the priority score Sp. The selection unit 26 may determine the priority score Sp according to the type of the dependent robot. For example, when a dependent robot existing in the different task execution system 50 that is different from the task execution system 50 where the robot 5 executing the target subtask exists, the selection unit 26 may set the priority score Sp of the target subtask to be a value higher than the value set when only the robot(s) 5 existing in a single task execution system 50 become dependent robot(s).

When the selection unit 26 determines, based on the work process information D3, that there exists a subtask whose execution order among the subtasks is fixed, the selection unit 26 sets the priority score Sp so that the execution order is observed. For example, in a case where two assistance request information D1 in the waiting state corresponding to the first subtask and the second subtask exist respectively, when it is recognized according to the work process information D3 that the first subtask is a task to be executed before the second subtask, the priority score Sp of the second subtask is set to a value less than the priority score Sp of the first subtask. Thus, the selection unit 26 performs the selection while appropriately observing the execution order among the subtasks.

As described above, the selection unit 26 determines the priority score Sp based on the work process information D3. Thereby, it is possible to suitably determine the target robot 5 and the subtask to be subjected to assistance without reducing the total work efficiency of the robot control system 100.

(5-2) Calculation of Priority Score Based on Similarity of Subtasks

The selection unit 26 may determine the priority score Sp based on the similarity among subtasks in addition to or in place of the work process information D3. Specifically, the selection unit 26 sets the priority score Sp corresponding to the subtask (specifically, the subtask having the same or a similar process as the subtask under external control) having a similarity to the subtask under external control by the external control unit 27 to a value higher than the priority score Sp corresponding to the other subtasks. In this case, for example, the assistance request information D1 includes the identification information of the target subtask of assistance, and the selection unit 26 determines the presence or absence of the similarity among the subtasks based on the identification information of the subtasks. In this case, for example, subtask classification information in which groups of the subtasks classified based on the similarity are associated with the identification information of the subtasks is stored in advance in the memory 22, and the selection unit 26 determines the similarity between any two subtasks based on the subtask classification information and the identification information of each subtask. In other cases, the assistance request information D1 may include a classification code representing a class of the target subtask of assistance that is classified based on the similarity.

It is noted that there are two or more subtasks having a similarity to one another among the subtasks corresponding to the assistance request information D1 in the waiting state, the selection unit 26 may set the priority score Sp so as to execute the two or more subtask in a row (for example, set the priority scores Sp of them to the same value).

As described above, the selection unit 26 determines the priority score Sp based on the similarity of the subtasks, which allows the operator of the assistance device 2 to perform the operations regarding the subtasks having the similarity in a row thereby to suitably improve the working efficiency of the operator.

(5-3) Calculation of Priority Score Based on Working Time Length

In place of or in addition to the above-described method of determining the priority score Sp, the selection unit 26 may determine the priority score Sp corresponding to the target subtask in consideration of the assumed working time length for the target subtask. For example, the selection unit 26 increases the priority score Sp corresponding to the target subtask with the decrease in the assumed working time length for the target subtask. In this case, for example, in the memory 22, the working time information indicating the working time length assumed for each identification information of the subtasks is stored, and the selection unit 26 recognizes the working time length assumed for each subtask based on the working time information and the identification number of each subtask.

The specific methods for determining priority score Sp will be supplemented. For example, in the memory 22, a look-up table or an expression that defines a relation between information to be considered in determining the priority score Sp″ and the priority score Sp to be set is stored, and the selection unit 26 determines the priority score Sp by referring to the information. Here, the “information to be considered in determining the priority score Sp” includes, for example, the number of the above-described dependent robots, the presence or absence of the similarity with a subtask under the external control, and/or an assumed working time length.

(5-4) Specific Examples

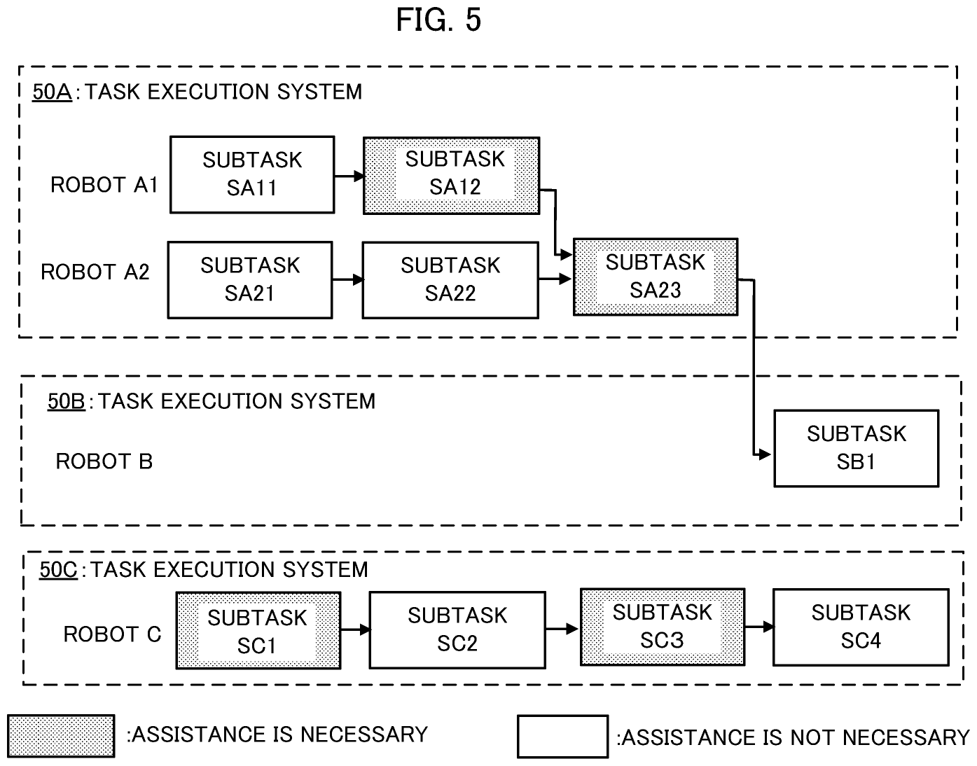

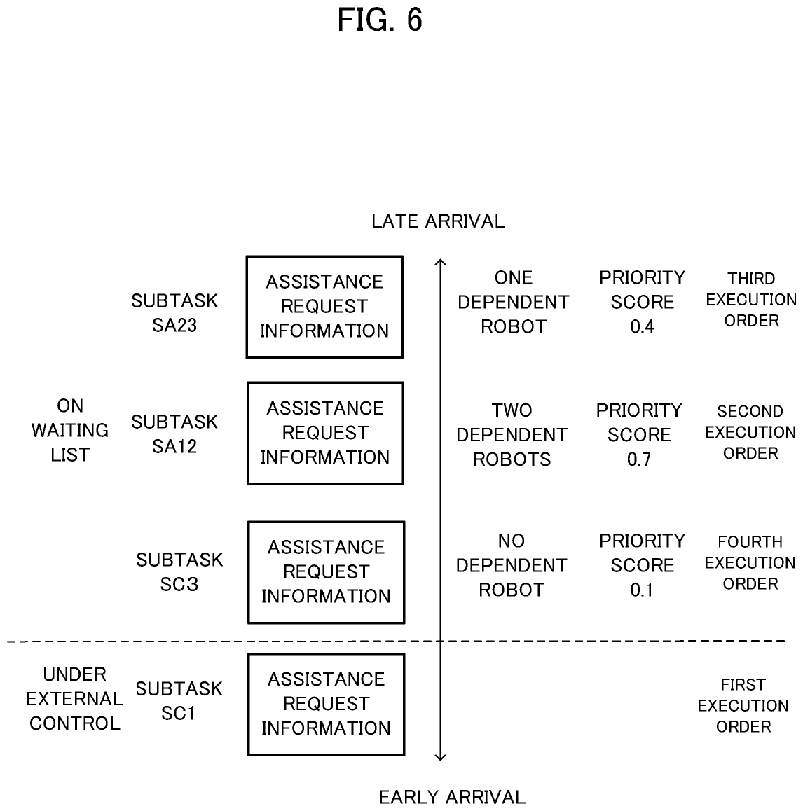

Next, specific examples of the processing of the selection unit 26 of the assistance device 2 will be described with reference to FIGS. 5 and 6.

FIG. 5 is a diagram in which the subtasks executed by the robots 5 in respective task execution systems 50 (50A to 50C) which execute objective tasks given at substantially the same time and the dependence relation among the subtasks are shown on the basis of the task process data D3. In FIG. 5, the subtasks (i.e., subtasks to be subjected to external control) that require the assistance of the assistance device 2 and the subtasks that do not require the assistance of the assistance device 2 (i.e., does not require external control) are color-coded. In FIG. 5, arrows indicate the order of execution among subtasks in which the execution order is defined.

As shown in FIG. 5, the task execution system 50A has a “robot A1” that executes a “subtask SA11” and a “subtask SA12” and a “robot A2” that executes a “subtask SA21” to a “subtask SA23” in order. In addition, the task execution system 50B has a “robot B” that executes a “subtask SB1” whose execution order is later than the subtask SA23 to be executed by the robot A2 in the task execution system 50A. The task execution system 50C includes a “robot C” that executes subtasks from a “subtask SC1” to a “subtask SC4” in order. The subtask SA12, the subtask SA23, the subtask SC1, and the subtask SC3 correspond to subtasks that assistance by the assistance device 2 is necessary.

Here, with respect to the subtask SA12 to be executed by the robot A1, the robot A2 which executes the subtask SA23 and the robot B of the task execution system 50B which executes the subtask SB1 fall under the dependent robots. In addition, with respect to the subtask SA23 to be executed by the robot A2, the robot B of the task execution system 50B executing the subtask SB1 corresponds to the dependent robot. On the other hand, the subtask SC1 and the subtask SC3 to be executed by the robot C in the task execution system 50C have no effect on the subtasks of the other robots 5, and there are no dependent robots corresponding thereto.

FIG. 6 is a diagram illustrating the order of arrival of the assistance request information D1 to the assistance device 2, the priority score Sp, and the execution order by the assistance device 2 corresponding to the respective subtasks which require assistance of the assistance device 2 in FIG. 5. Here, the assistance device 2 firstly receives the assistance request information D1 corresponding to the subtask SC1, and then receives the assistance request information D1 corresponding to the subtask SC3, the assistance request information D1 corresponding to the subtask SA12, and the assistance request information D1 corresponding to the subtask SA23 in order.

In this instance, the selection unit 26 of the assistance device 2 supplies the assistance request information D1 corresponding to the firstly-received subtask SC1 to the external control unit 27 since the external control unit 27 is in the standby state (i.e., the executable state) when receiving the assistance request information D1 corresponding to the subtask SC1. The external control unit 27 generates and transmits the external input signal D2 based on the operator's operation using the robot operation unit 24d on the basis of the assistance request information D1 corresponding to the subtask SC1.

Thereafter, during the period of process of the subtask SC1 by the external control unit 27, the selection unit 26 receives, in order, the assistance request information D1 of the subtask SC3, the assistance request information D1 of the subtask SA12, and the assistance request information D1 of the subtask SA23, and calculates the priority score Sp for them.

In the example shown in FIG. 6, the selection unit 26 recognizes the dependent robots of the respective subtasks corresponding to the assistance request information D1 in the waiting state on the basis of the work process information D3, and increases the priority score Sp (here, having a value range of 0 to 1) of a subtask with increase in the number of the dependent robots with respect to the subtask. Specifically, the selection unit 26 sets the priority score Sp for the subtask SC3 having no dependent robot to 0.1, the priority score Sp for the subtask SA23 having one dependent robot to 0.4, and the priority score Sp for the subtask SA12 having two dependent robots to 0.7. Consequently, the execution order by the external control unit 27, except for the subtask SC1 in execution, is equal to the order of the priority score Sp as follows: the subtask SA12; the subtask SA23; and the subtask SC3. It is noted that this execution order is provisional, and when the assistance device 2 receives the assistance request information D1 for another subtask during the execution of the subtask SA12, the execution order may change according to the priority score Sp of the other subtask corresponding to the received assistance request information D1. The selection unit 26 may determine the priority score Sp in further consideration of the similarity among subtasks and/or the work information of the robot 5 other than the work process information D3 such as the assumed work time length.

When the assistance device 2 receives the assistance request information D1 including a command to switch the target of the external control to a subtask different from the subtask in execution of the external control, the external control unit 27 switches the target subtask of the external control to the subtask specified in the assistance request information D1. Thereafter, when the external control of the specified subtask is completed, the external control unit 27 resumes the external control of the subtask that the external control was interrupted. In this case, the external control unit 27 may notify the task execution system 50 of restarting the external control. When there is a subtask having a priority score Sp higher than a threshold, the external control unit 27 may switch the target subtask of external control to the subtask having the priority score Sp higher than the threshold in the same way.

(6) Details of Operation Sequence Generation Unit

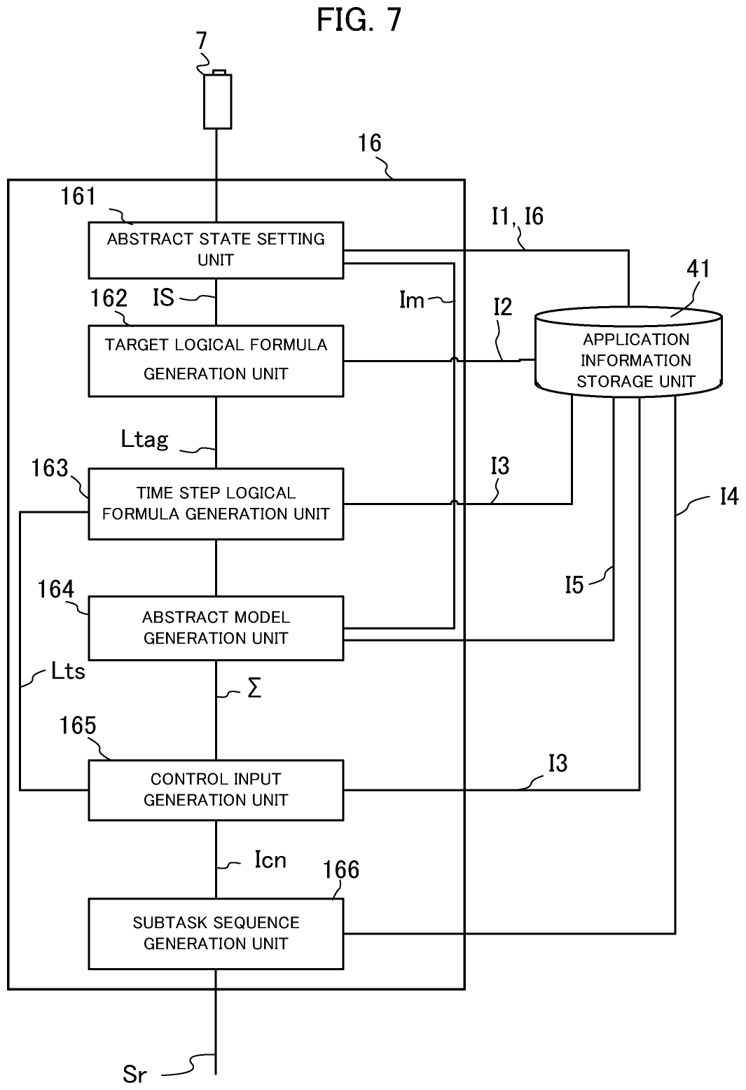

FIG. 7 is an example of a functional block showing the functional configuration of the operation sequence generation unit 16. The operation sequence generation unit 16 functionally includes an abstract state setting unit 161, a target logical formula generation unit 162, a time step logical formula generation unit 163, an abstract model generation unit 164, a control input generation unit 165, and a subtask sequence generation unit 166.

The abstract state setting unit 161 sets abstract states in the workspace based on: the measurement signal supplied from the measurement device 7; the abstract state designation information I1; and the object model information I6. In this instance, the abstract state setting unit 161 recognizes objects existing in the workspace that needs to be considered in executing the objective task and generates recognition result “Im” relating to the objects. Based on the recognition result Im, the abstract state setting unit 161 defines propositions to be expressed in logical formulas for respective abstract states that need to be considered in executing the objective task. The abstract state setting unit 161 supplies information (also referred to as “abstract state setting information IS”) indicating the set abstract states to the target logical formula generation unit 162.

Based on the abstract state setting information IS, the target logical formula generation unit 162 converts the objective task into a logical formula (also referred to as “target logical formula Ltag”), in the form of the temporal logic, representing the final state to be achieved. In this case, the target logical formula generation unit 162 refers to the constraint condition information I2 from the application information storage unit 41 and adds the constraint conditions to be satisfied in executing the objective task to the target logical formula Ltag. The target logical formula generation unit 162 supplies the generated target logical formula Ltag to the time step logical formula generation unit 163.

The time step logical formula generation unit 163 converts the target logical formula Ltag supplied from the target logical formula generation unit 162 into a logical formula (also referred to as “time step logical formula Lts”) representing the states at every time step. The time step logical formula generation unit 163 supplies the generated time step logical formula Lts to the control input generation unit 165.

The abstract model generation unit 164 generates an abstract model “E” in which the real dynamics in the workspace are abstracted, based on the abstract model information I5 stored in the application information storage unit 41 and the recognition result Im supplied from the abstract state setting unit 161. In this case, the abstract model Σ may be a hybrid system in which the continuous dynamics and the discrete dynamics are mixed. The abstract model generation unit 164 supplies the generated abstract model Σ to the control input generation unit 165.

The control input generation unit 165 determines a control input to the robot 5 for each time step so that the time step logic formula Lts supplied from the time step logical formula generation unit 163 and the abstract model Σ supplied from the abstract model generation unit 164 are satisfied and so that the evaluation function (e.g., a function representing the amount of energy consumed by the robot) is optimized. Then, the control input generation unit 165 supplies information (also referred to as “control input information Icn”) indicating the control input to the robot 5 for each time step to the subtask sequence generation unit 166.

The subtask sequence generation unit 166 generates an operation sequence Sr which is a sequence of subtasks based on the control input information Icn supplied from the control input generation unit 165 and the subtask information I4 stored in the application information storage unit 41, and supplies the operation sequence Sr to the robot control unit 17 and the switching determination unit 18.

(7) Details of Switching Determination Unit

The first to the third embodiments which are specific embodiments of switching from the first robot control to the second robot control by the switching determination unit 18 will be described in order.

In the first embodiment, the switching determination unit 18 determines whether or not the switching from the first robot control to the second robot control is necessary based on whether or not to execute an external input specific subtask that is a subtask predetermined to be executed by the second robot control. The subtask information I4 contains information regarding external input specific subtasks. Then, if the switching determination unit 18 determines that now is the execution timing of the external input specific subtask incorporated as a part of the operation sequence Sr, the switching determination unit 18 supplies the output control unit 15 and the robot control unit 17 with the switching command Sw instructing the switching from the first robot control to the second robot control.

Here, a supplementary description will be given of a method for recognizing the execution timing of an external input specific subtask in the first embodiment.

For example, the switching determination unit 18 recognizes the execution timing of the external input specific subtask based on the time step information associated with the respective subtasks of the operation sequence Sr. In this case, if the time corresponding to the time step corresponding to the external input specific subtask has come, the switching determination unit 18 determines that now is the execution timing of the external input specific subtask, and therefore supplies the output control unit 15 and the robot control unit 17 with the switching command Sw which instructs the switching from the first robot control to the second robot control.

In another example, the switching determination unit 18 determines, based on the completion notification of the subtask supplied from the robot 5 or the robot control unit 17, whether or not each subtask constituting the operation sequence Sr is completed, and recognizes the ongoing subtask currently executed by the robot 5. Even in this case, the switching determination unit 18 can suitably recognize the execution timing of the external input specific subtask. The switching determination unit 18 may recognize the execution timing of the external input specific subtask by recognizing the ongoing subtask currently executed by the robot 5 based on the measurement signal generated by the measurement device 7. In this case, for example, the switching determination unit 18 analyzes the measurement signal such as an image of the workspace by using any pattern recognition technique relating to deep learning or the like, and recognizes the ongoing subtask or the subtask to be executed by the robot 5.

According to the first embodiment, when systematically causing the robot 5 to execute the operation which requires the second robot control, the switching determination unit 18 can smoothly switch the control of the robot 5 from the first robot control to the second robot control.

Next, a description will be given of the second embodiment. In the second embodiment, the switching determination unit 18 determines whether or not to continue the first robot control based on the operation sequence Sr and the measured operation progress of the robot 5. In this case, if the amount of temporal or spatial deviation between the measured operation progress of the robot 5 and the predicted progress on the assumption that the operation sequence Sr is processed according to the plan at the time of generation of the operation sequence Sr is equal to or larger than a predetermined amount, the switching determination unit 18 determines that the continuation of the first robot control is inappropriate. Then, when it is determined that there is an obstacle to continue the first robot control, the switching determination unit 18 considers the continuation of the first robot control inappropriate and determines that it is necessary to switch to the second robot control.

According to the second embodiment, the switching determination unit 18 can smoothly perform switching from the first robot control to the second robot control in order to cope with an abnormal state.

In the third embodiment, in such a case that a plurality of operation sequences Sr are sequentially generated based on the one or more intermediate states until completion of the objective task, if any of the operation sequences Sr is not normally completed, the switching determination unit 18 determines that the switching to the second robot control is required.

In this case, as a premise, it is supposed that the operation sequence generation unit 16 sets one or more intermediate states (also referred to as “subgoals”) up to the completion state (goal) of the objective task. Then, the operation sequence generation unit 16 sequentially generates a plurality of operation sequences Sr required from the beginning to the completion of the objective task based on the subgoals. Specifically, the operation sequence generation unit 16 sequentially generates the operation sequence Sr for making a transition from the initial state to a first subgoal, the operation sequence Sr for making a transition from a subgoal to the subsequent subgoal, the operation sequence Sr for making a transition from the last subgoal to the completion state (goal). For example, the information necessary for setting the subgoals for each objective task is stored in the storage device 4 in advance, and the operation sequence generation unit 16 sets the subgoals by referring to the information. When the objective task is pick-and-place, the above-described information is, for example, information indicative of the maximum number of target objects of pick-and-place in one operation sequence Sr.

Then, the switching determination unit 18 determines, based on the completion notification or the like supplied from the robot control unit 17 for each operation sequence Sr, whether or not each operation sequence Sr is normally completed. Then, if there is an operation sequence Sr that is not completed normally, the switching determination unit 18 generates the switching command Sw. For example, if the switching determination unit 18 determines that operation sequences Sr for the same subgoal are generated in a row, it determines that some abnormality preventing the target subgoal from being completed has occurred and then supplies the switching command Sw to the output control unit 15 and the robot control unit 17.

According to the third embodiment, the switching determination unit 18 can accurately determine whether or not to switch from the first robot control to the second robot control.

(8) Robot Operation Screen Image

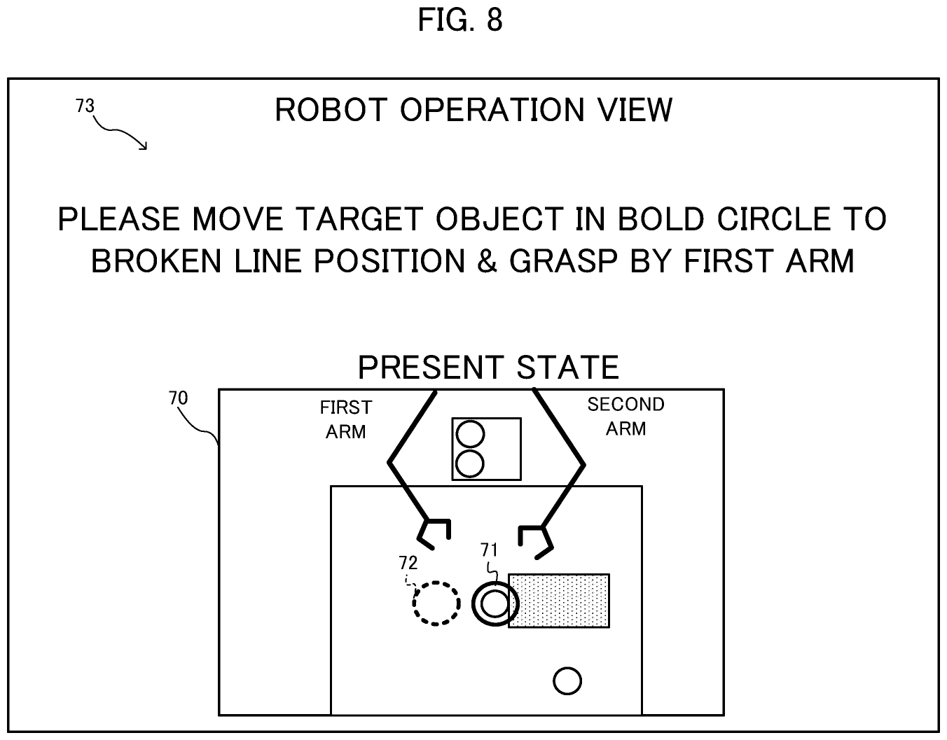

FIG. 8 is an example of a robot operation screen image displayed by the assistance device 2. The external control unit 27 of the assistance device 2 performs the display control of the robot operation screen image shown in FIG. 8 by receiving the operation screen image information from the robot controller 1 in the task execution system 50 that is the sender of the assistance request information D1 selected by the selection unit 26. The robot operation screen image shown in FIG. 8 mainly has a workspace display field 70 and an operation content display area 73.

Here, a workspace image is displayed in the workspace display field 70 and the content of operation of the robot 5 to be operated by external input is displayed in the operation content display area 73, wherein the workspace image is an image obtained by photographing the present workspace or a CAD image schematically representing the present workspace. As an example, it is herein assumed that the subtask of interest is a subtask to move a target object, which is adjacent to the obstacle and which the robot 5 cannot directly grasp, to such a position that the target object can be grasped.

In the example shown in FIG. 8, the assistance device 2 displays on the operation content display area 73 a guide sentence instructing the operation content (here, moving the target object to a predetermined position and grasping by the first arm) to be executed by the robot 5. Further, the assistance device 2 displays, on the workspace image displayed in the workspace display field 70, a bold circle 71 circling the target object of operation, a broken circle 72 indicating the movement destination of the target object, the name (first arm and second arm) of each arm of the robot 5. By adding such information to the work space display field 70, the assistance device 2 can suitably cause the operator who refers to the text in the operation content display area 73 to recognize the target robot arm of the operation, and the target object of the operation and the destination thereof.

It is noted that the content of the operation of the robot 5 shown in the operation content display area 73 satisfies one or more conditions (also referred to as “sequence transition conditions”) for making a transition to the subsequent subtask of the target subtask. The sequence transition conditions correspond to the conditions of the end state (or the start state of the subsequent subtask) of the target subtask assumed in the generated operation sequence Sr. The sequence transition conditions in the example shown in FIG. 8 requires that the first arm is in a state of grasping the target object at a predetermined position. Thus, by displaying the guide sentence instructing the operation necessary to satisfy the sequence transition conditions in the operation content display area 73, the assistance device 2 can suitably assist the external input necessary to smoothly make a transition to the subsequent subtask.

As described above, according to the robot operation screen image shown in FIG. 8, at the time of execution of the subtask which requires the second robot control, it is possible to suitably assist the worker so that an appropriate external input is made.

(9) Processing Flow

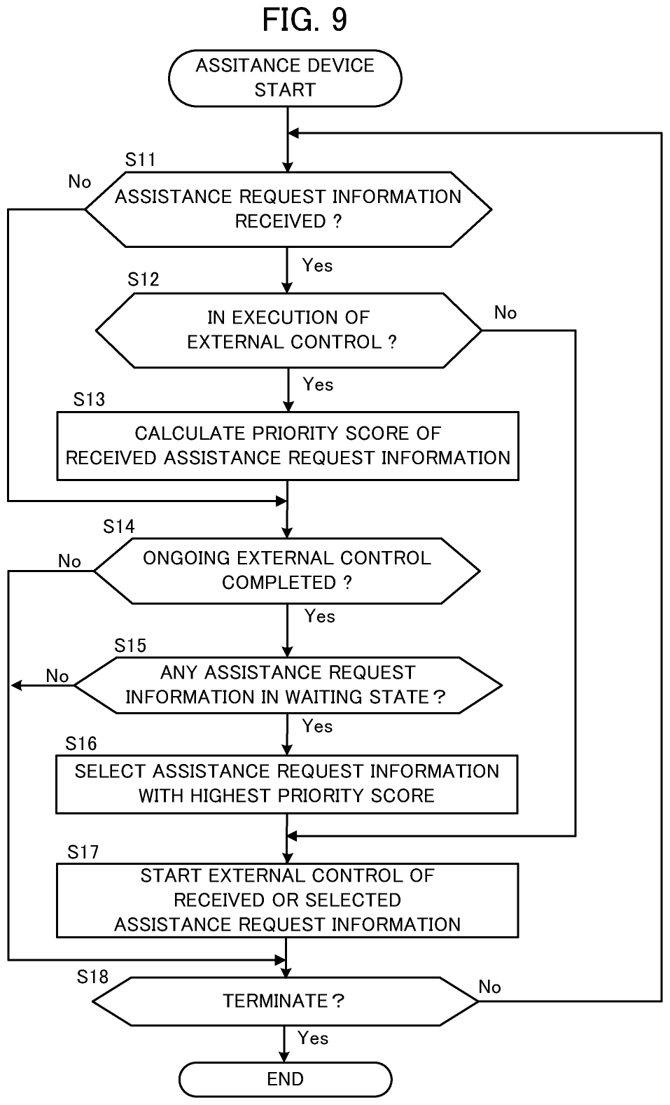

FIG. 9 is an example of a flowchart illustrating an outline of a robot control process that is executed by the assistance device 2 in the first example embodiment.

First, the selection unit 26 of the assistance device 2 determines whether or not the assistance request acquisition unit 25 has received the assistance request information D1 (step S11). When the assistance request acquisition unit 25 receives the assistance request information D1 (step S11; Yes), the selection unit 26 determines whether the external control unit 27 is in execution of the external control (step S12). Namely, the selection unit 26 determines whether or not the external control unit 27 is in execution of process of generating and transmitting the external input signal D2 based on the already received assistance request information D1. When the external control unit 27 is in execution of the external control (step S12; Yes), the selection unit 26 calculates the priority score Sp of the assistance request information D1 which the assistance request acquisition unit 25 received at step S11 (step S13). Then, the assistance request information D1 whose priority score Sp is calculated is shifted to be in a waiting state for external control by the external control unit 27.

On the other hand, when the assistance request acquisition unit 25 has not received the assistance request information D1 (step S11; No), the assistance device 2 proceeds with the process at step S14. After receiving the assistance request information D1 at step S11, if the external control unit 27 is not currently performing the external control (step S12; No), the external control unit 27 starts the external control based on the received assistance request information D1 (step S17). In this way, when there is no target subtask of assistance in execution, the external control unit 27 immediately executes the external control of the subtask specified by the received assistance request information D1.

Next, after calculating the priority score Sp at step S13, or if the assistance request information D1 is not received at step S11, the selection unit 26 determines whether or not the ongoing external control by the external control unit 27 has been completed (step S14). In other words, the selection unit 26 determines whether or not the subtask assisted by the external control unit 27 has been completed. Then, when the selection unit 26 determines that the ongoing external control by the external control unit 27 has been completed (step S14; Yes), it further determines whether or not there is assistance request information D1 in the waiting state (step S15). Then, when the assistance request information D1 in the waiting state exists (step S15; Yes), the selection unit 26 selects the assistance request information D1 having the highest priority score Sp (step S16). Then, the external control unit 27 starts the external control based on the assistance request informational D1 selected by the selection unit 26 (step S17). Thus, the assistance device 2 can determine the target subtask of assistance in comprehensive consideration of the whole work process and the like so that the work efficiency in the robot control system 100 is suitably improved.

On the other hand, if the external control unit 27 has not completed the ongoing external control (step S14; No), or when there is no assistance request information D1 in the waiting state (step S15; No), the assistance device 2 proceeds with the process at step S18. At step S18, the assistance device 2 determines whether or not to terminate the process of the flowchart (step S18). For example, if the robot control system 100 is out of the operation time or any other predetermined end condition is satisfied, the assistance device 2 determines that the processing of the flowchart should be terminated. Then, when the assistance device 2 determines that processing of the flowchart should be terminated (step S18; Yes), it ends the processing of the flowchart. On the other hand, if it is not to terminate the process of the flowchart (step S18; No), the assistance device 2 gets back to the process at step S11.

(10) Modifications

Next, a description will be given of the modifications of the first example embodiment. The following modifications may be applied in any combination.

(First Modification)

The management device 3 may be equipped with some functions of the assistance device 2 in place of the assistance device 2.

For example, the management device 3 is equipped with functions corresponding to the assistance request acquisition unit 25 and the selection unit 26, thereby to perform a process of the flowchart shown in FIG. 9 including: receiving the assistance request information D1 from the task executing system 50; calculating the priority score Sp for the received assistance request information D1; and selecting the target assistance request information D1 of external control by the external control unit 27. Then, at step S17 in FIG. 9, the management device 3 transmits the received or selected assistance request information D1 to the assistance device 2 to thereby cause the external control unit 27 of the assistance device 2 to perform the external control based on the assistance request information D1. In this instance, the management device 3 receives from the assistance device 2 information for determining, at step S12 and step S14, whether or not the external control unit 27 is in execution of the external control.

In this modification, the assistance device 2 and the management device 3 can assistance the task execution system 50 so as to improve the overall work efficiency of the robot control system 100. In this modification, the management device 3 functions as the “assistance control device”.

(Second Modification)

Instead of or in addition to performing control of displaying information to assist the external input from the operator on the robot operation screen image in the second robot control, the robot controller 1 may perform control of outputting information to assist external input from the operator by sound in the second robot control. In this case, the assistance device 2 causes, based on the information received from the robot controller 1, the assistance device 2 to perform audio output of the guidance corresponding to the guide sentence relating to the external input displayed on the operation content display area 73. According to this modification, the assistance device 2 can cause the operator to perform an external input necessary for external control by the external control unit 27.

(Third Modification)

The block configuration of the operation sequence generation unit 16 shown in FIG. 7 is an example, and various changes may be made thereto.

For example, information indicative of possible candidates of the operation sequence to be instructed to the robot 5 is previously stored in the storage device 4, and the operation sequence generation unit 16 executes optimization process by the control input generation unit 165 based on the information. Thus, the operation sequence generation unit 16 performs selection of the optimum candidate and determination of the control input of the robot 5. In this instance, the operation sequence generation unit 16 may not have a function corresponding to the abstract state setting unit 161, the target logical formula generation unit 162, and the time step logical formula generation unit 163 in generating the operation sequence Sr. In this way, information regarding the execution result of some functional blocks of the operation sequence generation unit 16 shown in FIG. 7 may be stored in advance in the application information storage unit 41.

In another example, the application information preliminary includes design information such as a flowchart for designing the operation sequence Sr corresponding to the objective task, and the operation sequence generation unit 16 may generate the operation sequence Sr by referring to the design information. For example, JP 2017-39170A discloses a specific example of executing a task based on a pre-designed task sequence.

### Second Example Embodiment

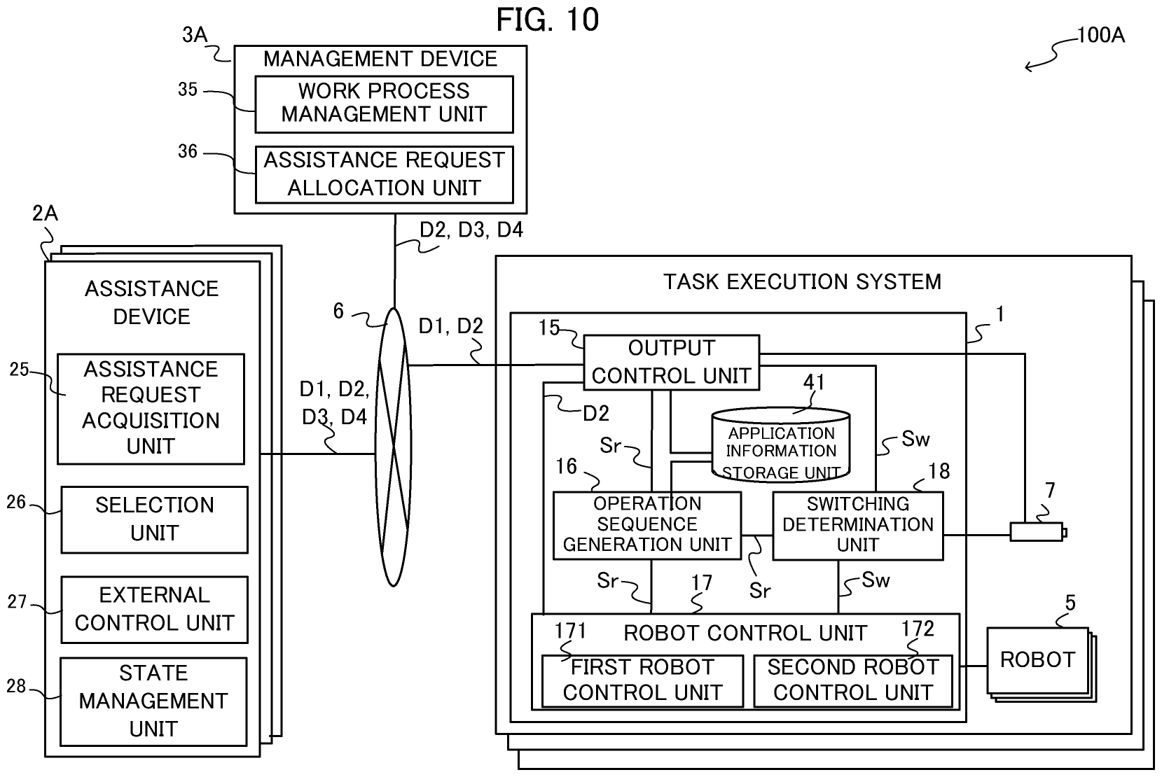

FIG. 10 shows the functional configuration of the robot control system 100A according to the second example embodiment. The robot control system 100A includes a plurality of assistance device 2A and differs from the robot control system 100 according to the first example embodiment in that the management device 3A performs a process of allocating assistance request information D1 to each of the assistance devices 2A. Hereinafter, the same components as in the first example embodiment are denoted by the same reference numerals as in the first example embodiment, and a description thereof will be omitted as appropriate. The hardware configurations of the robot controller 1, the assistance device 2A, and the management device 3A are the same as those shown in FIGS. 2A to 2C, respectively.

As shown in FIG. 10, the assistance device 2A functionally includes an assistance request acquisition unit 25, a selection unit 26, an external control unit 27, and a state management unit 28.

The assistance request acquisition unit 25 receives, from the management device 3A, the assistance request information D1 allocated by the management device 3A. Similar to the first example embodiment, the selection unit 26 calculates the priority score Sp for the assistance request information D1 acquired by the assistance request acquisition unit 25 and selects the target assistance request information D1 of external control by the external control unit 27. The external control unit 27 executes the external control based on the assistance request information D1 selected by the selection unit 26 as in the first example embodiment.

The state management unit 28 generates state information “D4” representing a state (more specifically, a state of a load caused by assistance) of assistance executed by the own assistance device 2A at predetermined or undefined time intervals, and transmits the generated state information D4 to the management device 3A. Here, the state information D4 indicates, for example, the assumed waiting time length from the time when the target assistance device 2A receives new assistance request information D1 to the time when the assistance request information D1 is undertaken. The waiting time length is, for example, a total time length of the assumed working time length of the ongoing subtask under external control by the external control unit 27 and the assumed working time length of the subtask(s) corresponding to the assistance request information D1 in the waiting state. In another example, the state information D4 may be information representing whether or not the external control is in execution and the number of assistance request information D1 in the waiting state when the external control is in execution.

The assistance request allocation unit 36 of the management device 3A receives the assistance request information D1 from each of the task execution systems 50 and transmits the received assistance request information D1 immediately (i.e., without hoarding the assistance request information D1) to any of the assistance devices 2A. In this instance, the assistance request allocation unit 36 determines the assistance device 2A to be the destination of the respective assistance request information D1 based on the latest state information D4 received from the assistance device 2A. For example, the assistance request allocation unit 36 transmits the received assistance request information D1 to the assistance device 2A having the lowest degree of load (e.g., the assumed waiting time length) indicated by the state information D4.

According to the second example embodiment, even when there are a plurality of the assistance devices 2A and the task execution systems 50, the management device 3A appropriately allocates the assistance requests considering the loads of the assistance devices 2A, thereby improving the work efficiency of the entire robot control system 100A.

### Third Example Embodiment

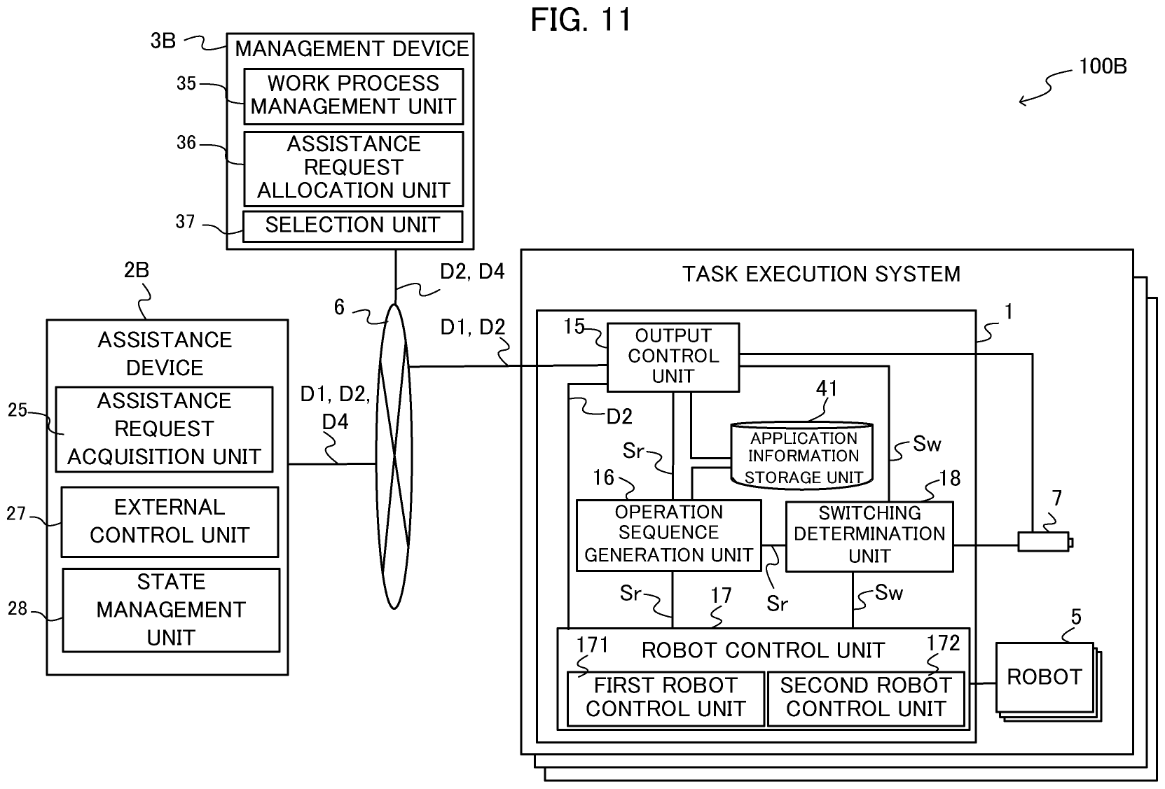

FIG. 11 shows a functional configuration of a robot control system 100B according to the third example embodiment. The robot control system 100B differs from the robot control system 100 according to the first example embodiment in that it has a plurality of assistance devices 2B and performs a process in which the management device 3B allocates the assistance request information D1 in the waiting state to an assistance device 2B available for assistance. Hereafter, the same components as those in the first example embodiment or the second example embodiment are denoted by the same reference numerals as those in the first example embodiment or the second example embodiment, and a description thereof will be omitted as appropriate. The hardware configurations of the robot controller 1, the assistance device 2B, and the management device 3B are the same as those shown in FIGS. 2A to 2C, respectively.

As shown in FIG. 11, the assistance device 2B functionally includes an assistance request acquisition unit 25, an external control unit 27, and a condition managing unit 28. The management device 3B functionally includes a work process management unit 35, an assistance request allocation unit 36, and a selection unit 37.

The assistance request acquisition unit 25 receives the assistance request information D1 allocated by the management device 3B from the management device 3B. The external control unit 27 executes external control based on the assistance request informational D1 received by the assistance request acquisition unit 25.

The state management unit 28 generates state information D4 representing a state (more specifically, a state of a load caused by assistance) of assistance executed by its own assistance device 2B at predetermined or undefined time intervals, and transmits the generated state information D4 to the management device 3B. Here, the state information D4 in the present example embodiment is information indicating whether or not it is a ready state for assistance. Therefore, when the external control by the external control unit 27 is in execution, the state management unit 28 generates the state information D4 representing that the assistance is not enabled. On the other hand, when the external control by the external control unit 27 is not in execution, the state managing unit 28 generates the state information D4 indicating that the assistance is enabled. The state management unit 28 may generate the state information D4 by further considering information regarding whether or not the operator is in an operable state (e.g., information regarding the presence or absence of the operator). For example, the state management unit 28 generates and transmits the state information D4 to the management device 3B at the timings of the start and completion of the external control.

Based on the state information D4, the assistance request allocation unit 36 of the management device 3 determines whether or not there is an assistance device 2B in the assistance ready state, and when there is an assistance device 2B in the assistance ready state, it transmits the assistance request information D1 selected by the selection unit 37 to the assistance device 2B.

The selection unit 37 receives and accumulates the assistance request information D1 from the task execution systems 50, and calculates the priority score Sp for each of the assistance request information D1 to be accumulated. When the assistance request allocation unit 36 determines that there is an assistance device 2B in the assistance ready state, the selection unit 37 supplies the assistance request allocation unit 36 with the assistance request information D1 having the highest priority score Sp at the present time as the selection result.

According to the third example embodiment, in such a case that there are a plurality of the assistance devices 2B and the task execution systems 50, the management device 3B allocates the assistance requests to the assistance devices 2A and improves the work efficiency of the entire robot control system 100A.

### Fourth Example Embodiment

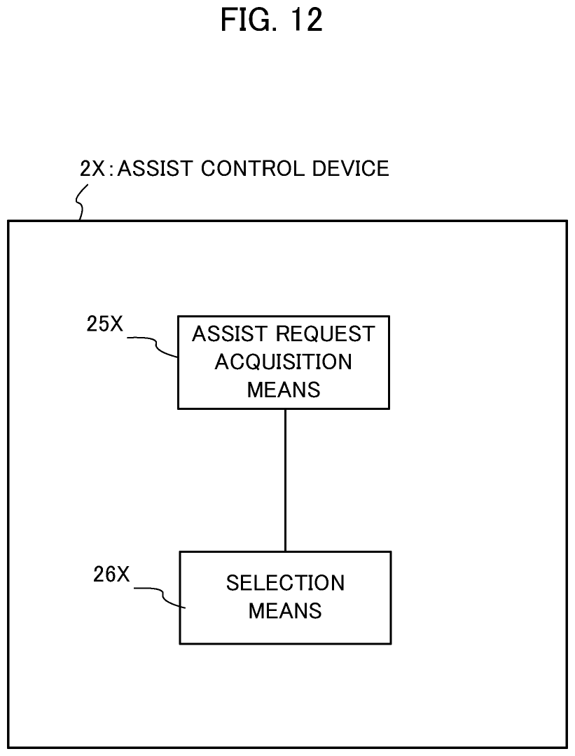

FIG. 12 shows a schematic configuration diagram of an assistance control device 2X in the fourth example embodiment. The assistance control device 2X mainly includes an assistance request acquisition means 25X and a selection means 26X. The assistance control device 2X may be configured by a plurality of devices. Examples of the assistance control device 2X include the assistance device 2A in the first example embodiment, the assistance device 2A in the second example embodiment, and the management device 3B in the third example embodiment.

The assistance request acquisition means 25X is configured to acquire assistance request information for requesting assistance, by external input, regarding a task to be executed by a robot. Examples of the assistance request acquisition means 25X include the assistance request acquisition unit 25 in the first example embodiment or the second example embodiment, and a selection unit 37 in the third example embodiment.

The selection means 26X is configured, if the assistance request information for plural tasks to be executed by plural robot is acquired, to select a task to be subjected to the assistance based on the assistance request information and work information regarding the plural robots. Examples of the selection means 26X include the selection unit 26 in the first example embodiment or the second example embodiment, and the selection unit 37 in the third example embodiment.

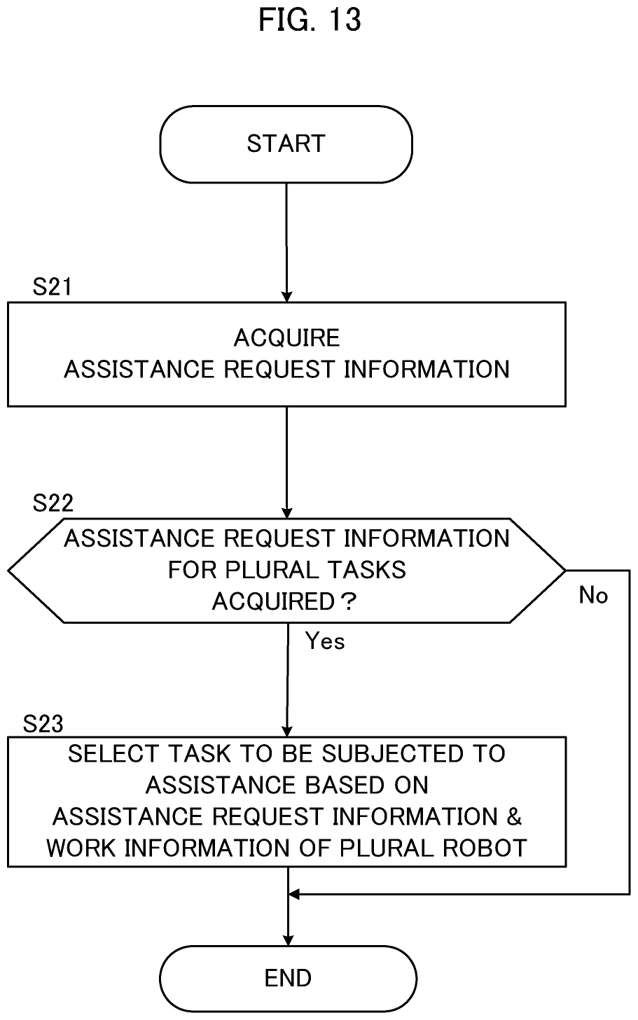

FIG. 13 is an example of a flowchart in the fourth example embodiment. The assistance request acquisition means 25X acquires assistance request information for requesting assistance, by external input, regarding a task to be executed by a robot (step S21). Then, if the assistance request information for plural tasks to be executed by plural robot is acquired (step S22; Yes), the selection means 26X selects a task to be subjected to the assistance based on the assistance request information and work information regarding the plural robots (step S23). Thereafter, the selected task is assisted. If the assistance request information for plural tasks to be executed by plural robot is not acquired (step S22; No), the flowchart processing is terminated. In this case, the assistance of the task corresponding to the acquired assistance request information is provided.

According to the fourth example embodiment, when the assistance request information for a plurality of tasks is acquired, the assistance control device 2X can suitably select the task to be subjected to assistance depending on the work progress of the robots.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An assistance control device comprising:
an assistance request acquisition means configured to acquire assistance request information for requesting assistance, by external input, regarding a task to be executed by a robot; and
a selection means configured, if the assistance request information for plural tasks to be executed by plural robot is acquired, to select a task to be subjected to the assistance based on the assistance request information and work information regarding the plural robots.

[Supplementary Note 2]

The assistance control device according to Supplementary Note 1,
wherein the selection means is configured, if the assistance request information for the plural tasks is acquired at a time when there is an ongoing task under the assistance, to
   calculate, based on the work information, a priority score regarding a priority of the assistance for each of the plural tasks and
   select, based on the priority score, a subsequent task to be subjected to the assistance.

[Supplementary Note 3]

The assistance control device according to Supplementary Note 2,
wherein the work information includes information regarding a dependence relation among the plural tasks, and
wherein the selection means is configured to calculate the priority score based on at least the dependence relation.

[Supplementary Note 4]

The assistance control device according to Supplementary Note 2 or 3,
wherein the work information includes information regarding a similarity among the plural tasks, and
wherein the selection means is configured to calculate the priority score based on at least the similarity.

[Supplementary Note 5]

The assistance control device according to any one of Supplementary Notes 2 to 4,
wherein the work information includes information regarding an assumed working time length of each of the plural tasks, and
wherein the selection means is configured to calculate the priority score based on at least the working time length.

[Supplementary Note 6]

The assist control device according to any one of Supplementary Notes 1 to 5,
wherein the selection means is configured, if the assistance request information for the plural tasks is acquired at a time when there is no ongoing task under the assistance, to
   select, as the task to be subjected to the assistance, a task firstly requested to be assisted among the plural tasks.

[Supplementary Note 7]

The assistance control device according to any one of Supplementary Notes 1 to 6, further comprising
an assistance request allocation means configured to transmit the assistance request information corresponding to the task selected by the selection means to an assistance device configured to generate the external input.

[Supplementary Note 8]

The assistance control device according to Supplementary Note 7,
wherein the assistance device is selected from plural assistance devices, and
wherein the assistance request allocation means is configured to determine the assistance device to which the assistance request is to be transmitted, based on state information regarding a state of each of the plural assistance devices with respect to the assistance.

[Supplementary Note 9]

An assistance device comprising:
an assistance control device according to any one of Supplementary Notes 1 to 6; and
an external control means configured to generate an external input for controlling the robot to execute the selected task.

[Supplementary Note 10]

A robot control system comprising:
an assistive control device according to any one of Supplementary Notes 1 to 8; and
a task execution system configured to transmit assistance request information to the assistance control device,
the task execution system comprising
   an assistance request information transmission means configured to
      specify a timing of starting the task and
      transmit the assistance request information indicative of the timing to the assistance control device before the specified timing.

[Supplementary Note 11]

The robot control system according to Supplementary Note 10,
wherein the assistance request information transmission means is configured to
   specify a timing of starting the selected task and a content of process of the task, and
   transmit the assistance request information indicative of the content of the process to the assistance control device before the specified timing.

[Supplementary Note 12]

The robot control system according to Supplementary Note 10 or 11,
wherein the assistance request information transmission means is configured to further acquire an external command which instructs the start of the task.

[Supplementary Note 13]

The robot control system according to any one of Supplementary Notes 10 to 12,
wherein the assistance request information transmission means is configured, if there is a task under the assistance, to
   transmit, to the assistance control device, the assistance request information including a command to switch the target of the assistance to a task with a priority score higher than the priority score for the task under the assistance.

[Supplementary Note 14]

A robot control system comprising:
plural assistance devices according to Supplementary Note 9; and
a management device configured to allocate assistance request information to the plural assistance devices,
each of the plural assistance devices further comprising
   a state management means configured to transmit, to the management device, state information regarding a state of the assistance in the each of the assistance devices,
the management device comprising
   an assistance request allocation means configured to allocate, based on the state information received from each of the plural assistance control devices, the assistance request information to the plural assistance devices.

[Supplementary Note 15]

An assistance control method executed by a computer, the assistance control method comprising:
acquiring assistance request information for requesting assistance, by external input, regarding a task to be executed by a robot; and
if the assistance request information for plural tasks to be executed by plural robot is acquired, selecting a task to be subjected to the assistance based on the assistance request information and work information regarding the plural robots.

[Supplementary Note 16]

A storage medium storing a program executed by a computer, the program causing the computer to:
acquire assistance request information for requesting assistance, by external input, regarding a task to be executed by a robot; and
if the assistance request information for plural tasks to be executed by plural robot is acquired, select a task to be subjected to the assistance based on the assistance request information and work information regarding the plural robots.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All patent and Non-Patent Literatures mentioned in this specification are incorporated by reference in its entirety.

### DESCRIPTION OF REFERENCE NUMERALS

1 Robot controller
2, 2A, 2B Assistance device
2X Assistance control device
3, 3A, 3B Management device
5 Robot
7 Measurement device
41 Application information storage unit
100 Robot control system

What is claimed is:

1. An assistance control device comprising:
at least one memory configured to store instructions; and
at least one processor configured to execute the instructions to:
acquire assistance request information for requesting assistance, by external input, regarding a task to be executed by a robot; and
if the assistance request information for plural tasks to be executed by plural robot is acquired, select a task to be subjected to the assistance based on the assistance request information and work information regarding the plural robots.

2. The assistance control device according to claim 1,
wherein the at least one processor is configured to execute the instructions, if the assistance request information for the plural tasks is acquired at a time when there is an ongoing task under the assistance, to
calculate, based on the work information, a priority score regarding a priority of the assistance for each of the plural tasks and
select, based on the priority score, a subsequent task to be subjected to the assistance.

3. The assistance control device according to claim 2,
wherein the work information includes information regarding a dependence relation among the plural tasks, and
wherein the at least one processor is configured to execute the instructions to calculate the priority score based on at least the dependence relation.

4. The assistance control device according to claim 2,
wherein the work information includes information regarding a similarity among the plural tasks, and
wherein the at least one processor is configured to execute the instructions to calculate the priority score based on at least the similarity.

5. The assistance control device according to claim 2,
wherein the work information includes information regarding an assumed working time length of each of the plural tasks, and
wherein the at least one processor is configured to execute the instructions to calculate the priority score based on at least the working time length.

6. The assist control device according to claim 1,
wherein the at least one processor is configured to execute the instructions, if the assistance request information for the plural tasks is acquired at a time when there is no ongoing task under the assistance, to
select, as the task to be subjected to the assistance, a task firstly requested to be assisted among the plural tasks.

7. The assistance control device according to claim 1,
wherein the at least one processor is configured to further execute the instructions to transmit the assistance request information corresponding to the selected task to an assistance device configured to generate the external input.

8. The assistance control device according to claim 7,
wherein the assistance device is selected from plural assistance devices, and
wherein the at least one processor is configured to execute the instructions to determine the assistance device to which the assistance request is to be transmitted, based on state information regarding a state of each of the plural assistance devices with respect to the assistance.

9. The assistance control device according to claim 1,
wherein the at least one processor is configured to further execute the instructions to generate an external input for controlling the robot to execute the selected task.

10-14. (canceled)

15. An assistance control method executed by a computer, the assistance control method comprising:
acquiring assistance request information for requesting assistance, by external input, regarding a task to be executed by a robot; and
if the assistance request information for plural tasks to be executed by plural robot is acquired, selecting a task to be subjected to the assistance based on the assistance request information and work information regarding the plural robots.

16. A non-transitory computer readable storage medium storing a program executed by a computer, the program causing the computer to:
acquire assistance request information for requesting assistance, by external input, regarding a task to be executed by a robot; and
if the assistance request information for plural tasks to be executed by plural robot is acquired, select a task to be subjected to the assistance based on the assistance request information and work information regarding the plural robots.
